(19) United States
(12) Patent Application Publication
(10) Pub. No.: US 2024/0322164 A1
(43) Pub. Date: Sep. 26, 2024

(54) CATHODE MATERIAL AND PREPARATION METHOD THEREOF AND SODIUM ION BATTERY

(71) Applicant: Hubei WanRun New Energy Technology Co., Ltd., Shiyan City (CN)

(72) Inventor: Qin WANG, Shiyan City (CN)

(21) Appl. No.: 18/605,075

(22) Filed: Mar. 14, 2024

(30) Foreign Application Priority Data
Mar. 21, 2023 (CN) 202310280551.7

(51) Int. Cl. H01M 4/58; C01B 33/32; H01M 4/02; H01M 4/36; H01M 4/587; H01M 10/054

(52) U.S. Cl. CPC H01M 4/5825; C01B 33/32; H01M 4/366; H01M 4/587; H01M 10/054; C01P 2004/03; C01P 2004/61; C01P 2004/80; C01P 2006/11; C01P 2006/12; C01P 2006/40; H01M 2004/021; H01M 2004/028

(57) ABSTRACT

The present disclosure relates to the technical field of sodium batteries, and in particular provides a cathode material for sodium batteries and a preparation method thereof. The cathode material for sodium batteries according to the present disclosure is carbon layer-coated sodium iron manganese titanium silicate, where the sodium iron manganese titanium silicate has a molecular formula of Na_{q}FeₓMn_{y}(TiO₂)_{z}(SiO₄)ₘ, where 1.5≤q≤2.5, 0.7≤x≤0.8, 0.2≤y≤0.3, 0.07≤z≤0.5, and 0.5≤m≤1.5. Compared with the prior art, the cathode material for sodium batteries provided by the present disclosure improves the capacity of resultant batteries by doping with titanium and manganese as well as carbon coating.

### CROSS-REFERENCE TO RELATED APPLICATIONS

This application claims priority to Chinese patent application No. 202310280551.7 filed on Mar. 21, 2023, which is incorporated herein by reference in its entirety.

### TECHNICAL FIELD

The present disclosure relates to the field of cathode materials for sodium batteries, and more particularly, to a cathode material for sodium batteries and a preparation method thereof.

### BACKGROUND

The research on sodium ion batteries has attracted continuous attention in recent years due to the abundant reserves of sodium resources and a working principle similar to that of lithium-ion batteries, and the sodium ion battery is one of the new energy storage technologies expected to promote low-cost applications and sustainable development of energy storage technology.

Polyanionic compounds are a class of high-performance and high-safety cathode materials which have been widely studied, and have strong covalent bonds in their structures that help stabilize the structural framework, thereby effectively improving the safety of the electrode during charging and discharging.

However, the polyanionic cathodes reported so far are difficult to achieve multi-electron reactions under the condition of a single polyanionic group, which severely limits their energy utilization. Taking sodium iron silicate (Na₂FeSiO₄) as an example, although theoretically it can achieve a two-electron reaction with a high theoretical capacity up to 276 mAh/g, its actual capacity is far below the theoretical capacity due to the low intrinsic electron conductivity of Na₂FeSiO₄, and the slow charge exchange process in the electrode, so the Na₂FeSiO₄ cathode cannot achieve multi-electron reactions within the safe voltage window of the electrolyte.

Professor JIANG, Yinzhu et al. from Zhejiang University designed the structural framework of sodium iron silicate, and chose fluoride ions as modifiers for oxygen substitution. Kinetically, the introduction of fluoride ions disrupts the local charge balance in the Na₂FeSiO₄ structure, increasing the electron transfer pathway and thereby accelerating charge transfer. Thermodynamically, the introduction of fluorine has been shown for the first time to stabilize the Fe⁴⁺-containing mesophase, thereby unlocking the Fe³⁺/Fe⁴⁺ redox reaction. The specific capacity of the prepared fluorine substituted sodium iron silicate cathode (NFSF) was up to 271 mAh/g, and a complete reversible two-electron reaction was achieved. However, the preparation process in the above-mentioned paper is relatively complex and cannot be industrialized.

### SUMMARY

In view of the above, it is an object of the present disclosure to provide a cathode material for sodium batteries and a preparation method thereof. Through doping with titanium and manganese, as well as carbon coating, the material becomes easier to process while enhancing the capacity of resultant batteries.

In order to achieve the above object, the present disclosure adopts the following technical scheme:
cathode material for sodium batteries, including a carbon layer-coated sodium iron manganese titanium silicate having a molecular formula of Na_{q}FeₓMn_{y}(TiO₂)_{z}(SiO₄)ₘ, where 1.5≤q≤2.5, 0.7≤x≤0.8, 0.2≤y≤0.3, 0.07≤z≤0.5, and 0.5≤m≤1.5.

The cathode material for sodium batteries according to the present disclosure has a specific surface area of 15-25 m²/g, preferably 19.75 m²/g; a powder resistivity of 8-12 Ω-cm, preferably 9.5 Ω-cm; a D50 particle size of 7-10 μm, preferably 7.8 μm; and a D90 particle size of 20-30 μm, preferably 25.3 μm.

The cathode material for sodium batteries according to the present disclosure has a tap density of 1-2 g/mL, preferably 0.95 g/mL; and
a compacted density of 1-3 g/mL, preferably 2.15 g/mL; and
the carbon layer has a thickness of 2-3 nm, preferably 2.5 nm.

The sodium iron manganese titanium silicate according to the present disclosure has a molecular formula of Na_{q}FeₓMn_{y}Ti_{z}(SiO₄)ₘ, where 1.5≤q≤2.5, 0.7≤x≤0.8, 0.2≤y≤0.3, 0.07≤z≤0.5, 0.5≤m≤1.5, preferably 1.8≤q≤2.0, 0.095≤z≤0.285, and 0.665≤m≤0.855.

The cathode material for sodium batteries according to the present disclosure has a formula of Na_{q}FeₓMn_{y}(TiO₂)_{z}(SiO₄)ₘ/C, where 1.5≤q≤2.5, 0.7≤x≤0.8, 0.2≤y≤0.3, 0.07≤z≤0.5, 0.5≤m≤1.5, preferably 1.8≤q≤2.0, 0.095≤z≤0.285, and 0.665≤m≤0.855.

In one example of the present disclosure, the sodium iron manganese titanium silicate has a molecular formula of Na_{1.97}Fe_{0.77}Mn_{0.25}(TiO₂)_{0.25}(SiO₄)_{0.77}, and the cathode material for sodium batteries has a molecular formula of Na_{1.97}Fe_{0.77}Mn_{0.25}(TiO₂)_{0.25}(SiO₄)_{0.77}/C.

The present disclosure also provides a preparation method of a cathode material for sodium batteries, including:
(1) mixing an iron source, a manganese source, a sodium source, and a solvent, and performing calcination to obtain a precursor;
(2) mixing the precursor with a silicate, a titanate, and an organic solvent to obtain a mixture, and calcining the mixture in the presence of an organic substance to obtain the cathode material for sodium batteries.

In the present disclosure, the molar ratio of the iron source, manganese source and sodium source is 1:(0.1-1):(5-10), preferably 1:(0.1-0.5):(7-10), and more preferably 1:0.45:7.

A mass ratio of the total mass of the iron source, manganese source and sodium source to the solvent is 1:(5-10), preferably 1:(4-8), and more preferably 1:6.

In the present disclosure, the molar ratio of sodium in the precursor, silicon in the silicate and titanium in the titanate is 2:(0.7-0.9):(0.1-0.3), preferably 2:0.8:0.25; and the mass ratio of the precursor to the organic solvent is 1:(1-10), preferably 1:(3-5), and more preferably 1:4.

In the step (2), the mass ratio of the organic substance to the mixture is 1:(0.02-0.05); the organic substance preferably participates in the calcination process in the form of gas, and the organic substance is preferably n-propanol gas. By vapor deposition method, carbon may be coated on the surface of sodium iron manganese titanium silicate more uniformly.

In the step (1) of the present disclosure, after the precursor is mixed with a silicate, a titanate and an organic solvent, a mixture is obtained, and the mixture is preferably pulverized; the pulverization is performed by way of grinding; and the grinding is performed at a temperature≤45° C. until a particle size of 130 nm is achieved.

Before the calcination, the mixture obtained by mixing the iron source, the manganese source, the sodium source, and the solvent is preferably dried, preferably spray dried.

The sodium source is one or more of sodium nitrate, sodium hydroxide, sodium carbonate, sodium oxalate, sodium nitrite, disodium hydrogen phosphate, sodium bicarbonate, sodium citrate, anhydrous sodium sulfate, sodium stearate, sodium oleate, sodium tartrate, sodium alginate, sodium carboxymethyl cellulose or sodium lactate, preferably sodium nitrate.

The iron source is one or more of iron nitrate, iron citrate, iron stearate, iron oleate, iron tartrate, iron alginate, iron carboxymethyl cellulose or iron lactate, preferably iron nitrate.

The manganese source is one or more of manganese nitrate, manganese citrate, manganese stearate, manganese oleate, manganese tartrate, manganese alginate, manganese carboxymethyl cellulose, or manganese lactate, preferably manganese nitrate.

The silicate is one or more of isopropyl orthosilicate, ethyl orthosilicate or trimethylsiloxy silicate, preferably isopropyl orthosilicate.

The phthalate is one or more of tetraisopropyl titanate, tetrabutyl titanate or tetraethyl titanate, preferably tetraisopropyl titanate.

Nitrate has the property of easy decomposition, which may greatly reduce the reaction temperature and shorten the reaction time, so that small primary particle size may be obtained and the subsequent reaction activity may be improved.

The calcination in the step (1) of the present disclosure is performed at a temperature of 650-750° C., preferably 700° C., for 4-6 h, preferably 5 h; after the calcination is completed, the material is preferably cooled to a temperature of ≤80° C. and then discharged; the heating rate of the calcination is preferably 2.5° C./h.

The waste gas generated during the calcination is preferably absorbed with a sodium hydroxide solution to obtain a sodium nitrate solution which may be reused.

In the step (2) of the present disclosure, the calcination is performed at a temperature of 620° C. for 10-15 h;

the calcination includes a heating stage, a heat preservation stage, and a cooling stage, where the oxygen content in the furnace is maintained to be less than 5 ppm during the heating process, and preferably nitrogen is introduced to maintain the oxygen content in the furnace to be less than 5 ppm, and the heating rate in the heating stage is 1.0-2.5° C./h;

in the heat preservation stage, an organic gas is introduced into the system, and the heat preservation time is 11-14 h;

in the cooling stage, the cooling rate is 1-1.5° C./h; the cooling is stopped when the temperature of the material is lowered to a temperature of ≤60° C., and then the material is discharged.

In one example of the present disclosure, the organic gas is gaseous n-propanol, which is pre-heated to a vapor state.

In the present disclosure, the solvent is one or more of water, ethanol, acetone, preferably water; and the organic solvent is one or more of ethanol, propanol, ethylene glycol, acetone, and preferably ethanol.

In the step (2) of the present disclosure, the mixture is subjected to drying treatment to obtain a dried material;
the drying is carried out in the presence of an inert gas; the inert gas is preferably nitrogen, and the temperature of the nitrogen is 330-350° C.; the drying treatment is preferably spray-drying; the spray-drying is preferably pressure spray-drying, the gas pressure of the spray-drying is 8-12 atmospheres, and the volume of the gas intake per unit time is 800-2000 times the volume of slurry feed;
after the spray-drying is completed, the spray-dried material and the organic gas enter a cyclone dust-collecting tower for solid-gas separation, the solid is collected, the nitrogen and the organic gas are filtered through a dust-collecting cloth bag, then condensed, the organic solvent is recovered, and the nitrogen is recycled for use.

In the present disclosure, the mass of the organic gas fed in total is 0.002-0.006 times, preferably 0.04 times the mass of the spray-dried mass.

In the step (2) of the present disclosure, before drying, the mixture is preferably subjected to grinding; using zirconium balls as the grinding medium, the grinding process is cooled with cooling water to maintain the temperature of the organic solvent≤45° C., and grinding is performed until the particle size of the slurry is 130 nm to obtain a ground material.

In the present disclosure, the preparation method further includes: in the step (2), the calcined material is mixed with a binder and a diluent, and spray granulation is performed to obtain the cathode material for sodium batteries.

The pulverized material is preferably sieved through an 80-150 mesh; the calcined material is pulverized, then subjected to electromagnetic iron removal, and then mixed with a binder and a diluent; the removal of iron continues until the content of magnetic substances is less than 1 ppm, and then it is stopped.

The binder is polyurethane; the diluent is one or more of ethyl acetate, toluene, dimethylformamide, glycol ether, glycol ester.

The cathode material for sodium batteries obtained by the preparation method according to the present disclosure has a particle size of 5-15 μm, and a core-shell structure. The inner core is sodium iron manganese titanium silicate, and the surface of the sodium iron manganese titanium silicate is uniformly coated with a 2-3 nm carbon layer.

The present disclosure also provides a battery including the above cathode material for sodium batteries.

The present disclosure does not have special requirements for other raw materials, such as the anode, and preparation methods of the battery, and may use conventional raw materials and methods in the art.

The beneficial effects of the present disclosure are:

1. A precursor is prepared by using an iron source, a manganese source and a sodium source, and a material with uniform mixing of manganese, iron and sodium may be obtained; iron ions, sodium ions and manganese ions are mixed at an atomic level using a solution method, then the spray-drying method is used for drying, and then high-temperature calcination is performed. Since the size range involved in the mixing is relatively small, the ion migration distance may be greatly reduced.

2. In designing the cathode material for sodium batteries in the present disclosure, silicate and titanium are introduced. The introduction of titanium may achieve the doping of titanium, improve the ionic conductivity and thus improve the capacity; the introduction of titanium may also effectively consume the residual free sodium on the surface of the material, and titanium forms sodium titanate with free sodium ions, thereby improving the processability and further improving the capacity of resultant batteries.

3. In the present disclosure, silicate esters and titanate esters are used as raw materials, the silicate esters and the titanate esters can be completely dissolved in an organic solvent. A silicate ester and a titanate ester are mixed with a precursor and then spray dried; the mixture of the precursor, the silicate ester and the titanate ester crystallizes and precipitates, making the mixing more thorough and the subsequent reactions more complete. Meanwhile, the alkyl groups in the organic substance thermally decomposes to produce a carbon source, which can effectively limit the growth of particles, obtaining materials with a small primary particle size. Compared to the method of introducing an additional carbon source, this can improve the carbon coating rate, and the coating effect is better. Also, in the organic system, the dispersibility of sodium iron manganese titanium silicate is better, making the primary particle size of the final product more uniform.

4. According to the present disclosure, during the heat preservation stage of calcination, organic gas is introduced into the system through a vapor deposition method. At sites where iron ions are not covered by carbon, i.e., where iron ions are exposed, organic gas will be catalytically cracked into carbon which adheres to these sites, further improving the uniformity of carbon coating.

5. In the spray-drying stage of the present disclosure, the particle size is controlled, and the final product is directly sieved without pulverization to achieve the granulation of spherical particles with a particle size of 5-15 μm. The spray drying may increase the solid content in the final process of slurry homogenization, thereby improving the processability, reducing cost, and also improving the compacted density of the product's electrode plate.

### BRIEF DESCRIPTION OF DRAWINGS

FIG. 1 is an SEM image of the sintered and unpulverized precursor in step (1) of Example 1;

FIG. 2 is an SEM image of the sintered and pulverized precursor in step (1) of Example 1;

FIG. 3 is an SEM image of the cathode material for sodium batteries obtained from Example 1;

FIG. 4 is a transmission electron micrograph of the pulverized cathode material for sodium batteries obtained from Example 1;

FIG. 5 is the charge-discharge curve of the cathode material for sodium batteries obtained from Example 1;

FIG. 6 is the cyclic curve of the cathode material for sodium batteries obtained from Example 1.

### DETAILED DESCRIPTION

The technical solutions of the present disclosure will be described clearly and completely with reference to the following examples, and it should be apparent that the described examples are a part, not all, examples of the present disclosure. Based on the examples of the present disclosure, all other examples obtained by a person skilled in the art without inventive effort fall within the scope of the present disclosure.

In order to further illustrate the present disclosure, the following examples are set forth in detail. The starting materials used in the following examples of the present disclosure are commercially available.

Electrochemical performance test: the proportion (mass ratio) of the electrode plate is electrode material: conductive graphite: PVDF=87:8:5.

CR2025 button cell was prepared with sodium metal as the reference electrode. The negative electrode was sodium plate and the electrolyte was sodium hexafluorophosphate. After the prepared button cell was allowed to stand at room temperature (25° C.) for 10 hours, the button cell was subjected to charge-discharge activation, and then the button cell was subjected to charge-discharge cycling test using a LAND battery charge-discharge tester.

The batteries were first cycled at a rate of 0.1 C for 1 week, then at a rate of 0.2 C for an additional 1 week, then at a rate of 0.5 C for an additional 1 week, and then at a rate of 1 C for an additional 1 week at room temperature (25° C.), where the charge-discharge voltage range of the batteries was controlled to in the voltage window of 1.0-4.5V for detection.

### Additional Performance Tests

Measurement of tap density: 50 g of material was taken, placed in a calibrated 100 mL graduated cylinder, vibrated with an amplitude of 2 cm for 5000 cycles, and the tap density was calculated.

Measurement of compacted density: An electronic compacted density meter was used to take 1 g of material, place it in a mold, apply a pressure of 3T for 30 s, and then calculate its density as the compacted density.

### Example 1

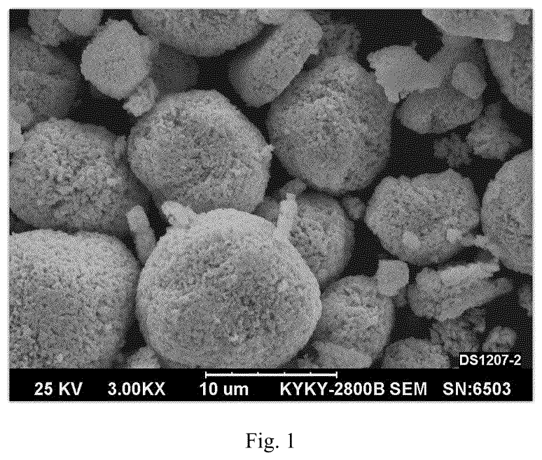

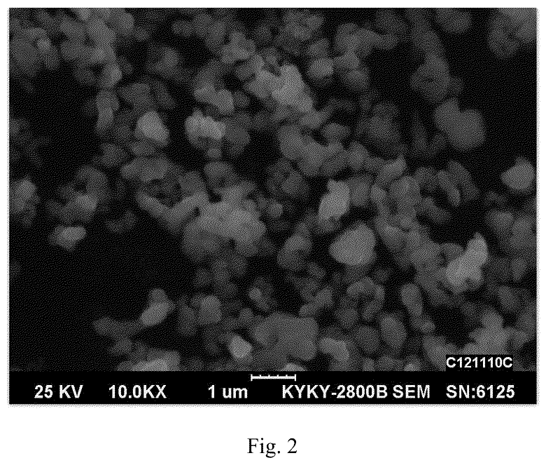

(1) Iron nitrate, manganese nitrate and sodium nitrate were mixed in a mass ratio of 0.75:0.25:1.9, pure water was added, dissolved, and mixed uniformly, with the mass ratio of the total mass of iron nitrate, manganese nitrate and sodium nitrate to the mass of pure water being 1:6. Then the mixture was heated up to 700° C. at a rate of 2.5° C./h, calcined for 5 hours, and then cooled until the material temperature was ≤80° C. before discharging. The waste gas generated during calcination was absorbed with sodium hydroxide solution to obtain sodium nitrate solution for recycling. The precursor can be obtained by the method of step (1), and the main components of the precursor were a mixture of iron nitrate, manganese nitrate and sodium nitrate. The performance test data of the precursor is shown in Table 1. The SEM images of the precursor before and after pulverization are shown in FIGS. 1 and 2, respectively.

TABLE 1

| Indexes | Na | Fe | Mn |
|---|---|---|---|
| Data | 30.18% | 28.91% | 9.52% |

| Tap density | Apparent density | D10 | D50 |
|---|---|---|---|
| 1.19 g/mL | 0.62 g/mL | 0.21 μm | 0.72 μm |

| D90 | BET | Ca | Mg |
|---|---|---|---|
| 3.75 μm | 7.4 m²/g | 31.5 ppm | 18.9 ppm |

(2) The precursor was mixed with isopropyl orthosilicate and tetraisopropyl titanate, the molar ratio of sodium in the precursor, silicon in the silicate and titanium in the titanate was 2:0.8:0.25. Ethanol solvent was added with a precursor to ethanol mass ratio of 1:4. The mixture was placed into a sand mill for grinding, using zirconium balls as grinding media. The grinding process was cooled with cold water to maintain the temperature of the organic solvent at ≤45° C., and the mixture was grinded until the particle size of the slurry was 130 nm to obtain a ground material.

(3) The ground material was subjected to pressure spray drying with nitrogen as a heating medium, the nitrogen was heated to 330° C., then introduced into a spray drying tower to dry the sprayed droplets. The organic solvent was gasified, then the spray-dried material and the organic gas entered a cyclone dust-collecting tower for solid-gas separation. The solid was collected, the nitrogen and the organic gas were filtered through a dust-collecting cloth bag, and then condensed, the organic solvent was recovered, and the nitrogen was recycled for use. In the spray drying process, the gas pressure for pressure spray drying was 9 atmospheres, and the volume of gas intake per unit time was 1500 times of the volume of slurry feed. Spray-dried material with a D50 particle size of 9.2 μm was obtained through the above-mentioned steps.

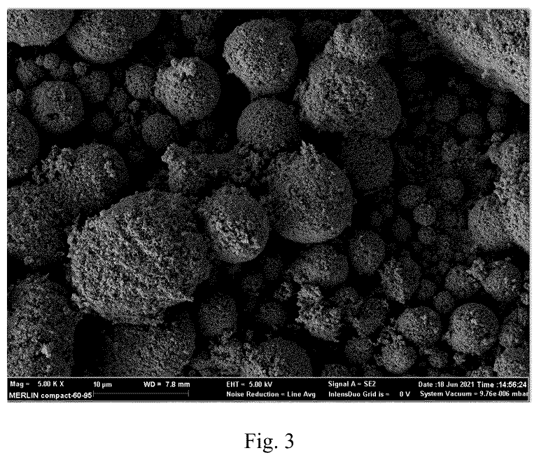

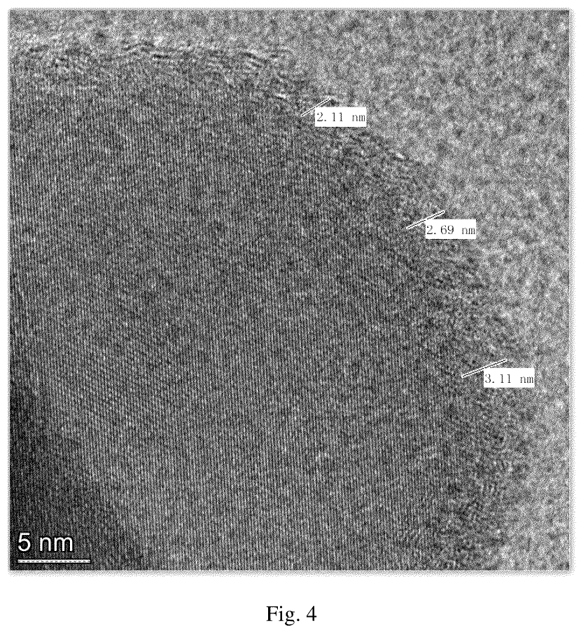

(4) The spray-dried material was placed into an atmosphere furnace for calcination, and the calcination included a heating stage, a heat preservation stage and a cooling stage. Nitrogen was introduced into the heat preservation stage during the calcination to maintain the oxygen content in the furnace below 5 ppm. The heating rate in the heating stage was 1.3° C./h, reaching a temperature of 620° C. The material was then held at this temperature for 13 hours before cooling. The cooling rate was 1.4° C./h, and the cooling continued until the material temperature was ≤60° C. before stopping, and then the material was discharged. During the holding stage, n-propanol was introduced into the system. N-propanol, preheated to a vapor state, was injected into the bottom of the loading sagger in the furnace through a gas pipe, with the total mass of organic gas introduced being 0.04 times the mass of the spray-dried material. The cooled material was pulverized, sieved with 125 mesh, electromagnetically de-ironed until the content of the magnetic substance was less than 0.87 ppm, and then the operation was stopped. The product was mixed with polyurethane binder and ethyl acetate, and then direct spray granulation was performed without pulverization, resulting in spherical carbon-coated cathode material for sodium batteries, with a molecular formula of Na_{1.97}Fe_{0.77}Mn_{0.25}(TiO₂)_{0.25}(SiO₄)_{0.77}/C, and a particle size of 7.8 μm. The SEM image is shown in FIG. 3, and the performance is shown in Table 2. The pulverized cathode material for sodium batteries was subjected to transmission electron microscopy testing, and the results were shown in FIG. 4. It can be seen that the surface of sodium iron manganese titanium silicate was coated with a carbon layer of about 2.5 nm, and the sodium iron manganese titanium silicate was uniformly coated by the carbon layer.

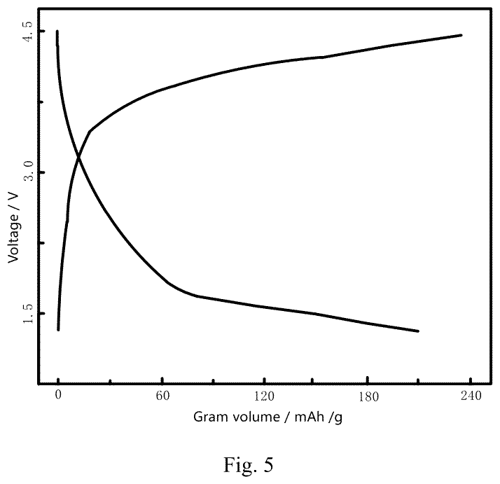

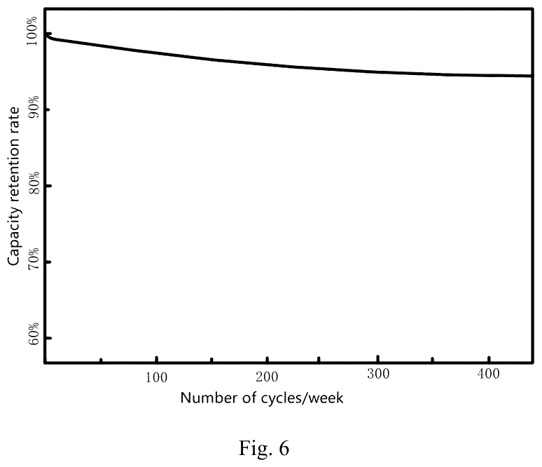

The cathode material for sodium batteries according to the present disclosure was assembled into a battery, and the charge-discharge curve is shown in FIG. 5, and the cycle curve is shown in FIG. 6.

TABLE 2

| Indexes | Na content | Fe content | Mn content | Si content |
|---|---|---|---|---|
| Data | 22.69% | 21.61% | 7.02% | 11.89% |

| | | Compacted | BET specific | Powder |
|---|---|---|---|---|
| Ti | Tap density | density | surface area | resistivity |
| 4.95% | 0.95 g/mL | 2.15 g/mL | 19.75 m²/g | 9.5 Ω cm |

| Free sodium | pH | C | Ca | Mg |
|---|---|---|---|---|
| 69.8 ppm | 9.35 | 2.74% | 36.2 ppm | 21.9 ppm |

| | | | | Magnetic |
|---|---|---|---|---|
| Co | Ni | Cu | Zn | foreign matter |
| 0.6 ppm | 1.2 ppm | 0.2 ppm | 12.5 ppm | 0.87 ppm |

| 0.1 C | 0.1 C | First | 0.5 C | 1 C |
|---|---|---|---|---|
| charge | discharge | discharge | discharge | discharge |
| capacity | capacity | efficiency | capacity | capacity |
| 231.1 mAh/g | 210.3 mAh/g | 91.0% | 207 mAh/g | 195 mAb/g |

| Capacity retention | 1 C Ambient | Iron | Manganese | |
|---|---|---|---|---|
| rate at −20° C. | temperature cycle | dissolution | dissolution | D10 |
| 86.7% | 450 weeks, | 14.8 ppm | 21.5 ppm | 2.9 μm |
| | capacity retention | | | |
| | rate of 95.2% | | | |

| D50 | D90 |
|---|---|
| 7.8 μm | 25.3 μm |

As can be seen from the data that the material provided in the present disclosure exhibits a remarkably high capacity and a long cycle life.

### Comparative Example 1

Referring to the procedure and condition parameters in Example 1, the precursor obtained in step (1) was mixed with silica and titania, and ethanol was added to carry out the subsequent test. The molar ratio of sodium in the precursor, silicon in silica and titanium in titania is 2:0.8:0.25.

The performance test of the product obtained in this Comparative Example is shown in Table 3 below. It can be seen that the cathode material for sodium ion batteries prepared from the raw materials not only exhibits a significant decrease in initial discharge efficiency but also experiences a substantial reduction in capacity retention at both −20° C. and room temperature.

TABLE 3

| | | 0.1 C | 0.1 C | First |
|---|---|---|---|---|
| | | charge | discharge | discharge |
| Indexes | BET | capacity | capacity | efficiency |
| Data | 13.62 m²/g | 193.1 mAh/g | 160.5 mAh/g | 83.12% |

| 0.5 C | 1 C | capacity | 1 C Ambient | |
|---|---|---|---|---|
| discharge | discharge | retention rate | temperature | Compacted |
| capacity | capacity | at −20° C. | cycle | density |
| 149.1 mAh/g | 143.2 mAh/g | 80.1% | 450 weeks, | 2.29 g/mL |
| | | | capacity retention | |
| | | | rate of 93.2% | |

The above description of the disclosed examples is provided to enable a person skilled in the art to implement or utilize the present disclosure. Various modifications to these examples will be readily apparent to a person skilled in the art, and the generic principles defined herein may be implemented in other examples without departing from the spirit or scope of the present disclosure. Thus, the present disclosure is not intended to be limited to the examples shown herein but is to conform to the widest scope consistent with the principles and novel features disclosed herein.

What is claimed is:

1. A cathode material for sodium batteries, comprising a carbon layer-coated sodium iron manganese titanium silicate having a molecular formula of Na_{q}FeₓMn_{y}(TiO₂)_{z}(SiO₄)ₘ, wherein 1.5≤q≤2.5, 0.7≤x≤0.8, 0.2≤y≤0.3, 0.07≤z≤0.5, and 0.5≤m≤1.5.

2. The cathode material for sodium batteries of claim 1, wherein the cathode material for sodium batteries has a specific surface area of 15-25 m²/g, a powder resistivity of 8-12 Ω·cm, and a D50 particle size of 7-10 μm.

3. The cathode material for sodium batteries of claim 1, wherein the cathode material for sodium batteries has a tap density of 1-2 g/mL and a compacted density of 1-3 g/mL; and
the carbon layer has a thickness of 2-3 nm.

4. A preparation method of a cathode material for sodium batteries, comprising:
(1) mixing and calcining an iron source, a manganese source, a sodium source, and a solvent to obtain a precursor; and
(2) mixing the precursor with a silicate, a titanate, and an organic solvent to obtain a mixture, and calcining the mixture in the presence of an organic substance to obtain the cathode material for sodium batteries.

5. The preparation method of a cathode material for sodium batteries of claim 4, wherein a molar ratio of the iron source, the manganese source, and the sodium source is 1:(0.1-1):(5-10).

6. The preparation method of a cathode material for sodium batteries of claim 4, wherein the molar ratio of sodium in the precursor, silicon in the silicate, and titanium in the titanate is 2:(0.7-0.9):(0.1-0.3); and
a mass ratio of the organic substance to the mixture is 1:(0.02-0.05).

7. The preparation method of a cathode material for sodium batteries of claim 4, wherein the sodium source is one or more of sodium nitrate, sodium nitrite, sodium citrate, sodium stearate, sodium oleate, sodium tartrate, sodium alginate, sodium carboxymethyl cellulose or sodium lactate;
the iron source is one or more of iron nitrate, iron citrate, iron stearate, iron oleate, iron tartrate, iron alginate, iron carboxymethyl cellulose, or iron lactate;
the manganese source is one or more of manganese nitrate, manganese citrate, manganese stearate, manganese oleate, manganese tartrate, manganese alginate, manganese carboxymethyl cellulose, or manganese lactate;
the silicate is one or more of isopropyl orthosilicate, ethyl orthosilicate or trimethylsiloxy silicate; and
the titanate is one or more of tetraisopropyl titanate, tetrabutyl titanate or tetraethyl titanate.

8. The preparation method of a cathode material for sodium batteries of claim 4, wherein in the step (1), the calcination is performed at a temperature of 650-750° C. for 4-6 h; and in the step (2), the calcination is performed at a temperature of 620° C. for 10-15 h.

9. The preparation method of a cathode material for sodium batteries of claim 4, further comprising: in the step (2), mixing the calcined material with a binder and a diluent, and performing spray granulation to obtain the cathode material for sodium batteries.

10. A battery comprising the cathode material for sodium batteries of claim 1.
